(19) United States
(12) Patent Application Publication
(10) Pub. No.: US 2015/0348405 A1
(43) Pub. Date: Dec. 3, 2015

(54) REMOTE CONTROL FOR HOUSEHOLD APPLIANCE AND SETTING METHOD THEREOF

(71) Applicant: Cybiowin Electronic (ShenZhen) Company Limited, Shenzhen City (CN)

(72) Inventors: BOON CHEN LIM, Shenzhen City (CN); YEUNG HOW LIM, Shenzhen City (CN)

(21) Appl. No.: 14/794,800

(22) Filed: Jul. 8, 2015

Related U.S. Application Data
(63) Continuation-in-part of application No. PCT/CN2014/078618, filed on May 28, 2014.

(51) Int. Cl. G08C 23/04

(52) U.S. Cl. CPC G08C 23/04; G08C 2201/31; G08C 2201/70

(57) ABSTRACT

A remote control comprises a built-in microprocessor, a built-in voice generator and a memory. The voice generator and the memory are data communicable with the microprocessor. Voice prompts are generated by the voice generator under control of the microprocessor to prompt users step by step when the remote control is set up to remotely control a household appliance to be remotely controlled. A first letter of a brand name corresponding to the household appliance to be remotely controlled is input in the remote control by following the generated voice prompts to decide a control code retrieved from the database for setting up the remote control, and further voices prompts are generated to prompt users for testing each key available for remotely controlling the household appliance to be remotely controlled. A method for setting the remote control is also provided.

### CROSS REFERENCE

The application is a U.S. continuation-in-part application under 35 U.S.C. §111(a) claiming priority under 35 U.S.C. §120 and §365(c) to International Application No. PCT/CN2014/078618 filed on May 28, 2014, the contents of which are incorporated by reference herein in their entirety for all intended purposes.

### FIELD OF THE INVENTION

The present invention relates to remote controls, especially relates to a remote control for household appliances having a built-in voice generator which is able to generate voice prompt(s) for guiding users to follow instruction(s) from the voice prompt(s) in order to operate and/or set up the remote control, and relates to a setting method of the remote control.

### DESCRIPTION OF RELATED ART

A universal remote control is variously used to control many kinds of household appliances. However, a conventional universal remote control is required to learn from another remote control which is originally used for a particular household appliance before use. It will be inconvenient if no originally used remote control is available for being learnt. Besides, traditional learning methods of universal remote controls require the universal remote control to learn from the originally used remote control one key by one key. As a result, its learning process is time consuming and laborious and operations thereof for users are complicated and inflexible.

### SUMMARY OF THE INVENTION

To solve the aforementioned technical problems, the present invention provides a remote control for household appliances and a setting method of the remote control. The remote control and its setting method are much flexible and provide simplified steps during its learning procedure. Hence, the remote control is simple to operate, and its learning procedure is simple and fast.

The remote control in accordance with the present invention comprises a built-in microprocessor, a built-in voice generator and a memory. The voice generator and the memory are data communicable with the microprocessor. A database is preset in the memory. Voice prompts are generated by the voice generator under control of the microprocessor to prompt users step by step when the remote control is set up to remotely control a household appliance to be remotely controlled. A first letter of a brand name corresponding to the household appliance to be remotely controlled is input in the remote control by following the generated voice prompts to decide a control code retrieved from the database for setting up the remote control, and further voices prompts are generated to prompt users for testing each key available for remotely controlling the household appliance to be remotely controlled when the corresponding brand name is input and the control code is decided to finish setting up of the remote control.

Preferably, the control code is an infrared (IR) code for setting up of the remote control, each IR code is stored in the database correspondingly to a brand name of an assigned household appliance to be remotely controlled by the remote control.

Preferably, numeric keys disposed on a control panel of the remote control is used for inputting of the first letter.

Preferably, the a set of brand names starting with the input first letter and being retrieved from the database is voice prompted for users to select the brand name corresponding to the household appliance to be remotely controlled from the set of brand names.

Preferably, a list of popular brand names is stored in the database for use of voice prompting users to select the brand name corresponding to the household appliance to be remotely controlled from the list.

In order to solve the aforementioned technical problems, the present invention further provides a setting method of the remote controller for household appliances. The method comprises a step of establishing a database in the remote control, a step of voice prompting the users to input a first letter of a brand name corresponding to a household appliance to be remotely controlled, a step of voice prompting a set of brand names retrieved from the database of the remote control and starting with the input first letter for users to select the brand name corresponding to the household appliance to be remotely controlled, and a step of completing setting of the remote control to make the remote control available for remotely controlling the household appliance to be remotely controlled by using the database based on the selected brand name.

Preferably, the method further comprises a step of initiating test of keys of the remote control available for controlling the household appliance to be remotely controlled one by one.

Preferably, the method further comprises a step of voice prompting users to switch on the household appliance to be remotely controlled and to memorize a brand name corresponding to the household appliance to be remotely controlled.

Preferably, the method further comprises a step of voice prompting users to select an appliance type of the household appliance to be remotely controlled.

Preferably, a control code used to set up the remote control ready for remotely controlling the household appliance to be remotely controlled is retrieved from the database after the brand name corresponding to the household appliance to be remotely controlled is selected.

The physical embodiments adopted in the present invention will be presented by the following depicted embodiments and accompanying drawings for further explanations.

### BRIEF DESCRIPTION OF THE DRAWINGS

FIG. 1 is a schematic plan view of a control panel of a remote control for a household appliance in accordance with a preferred embodiment of the present invention.

FIG. 2 is a partial schematic plan view of the control panel of the remote control in accordance with the present invention as shown in FIG. 1.

FIG. 3 is another partial schematic plan view of the control panel of the remote control in accordance with the present invention as shown in FIG. 1.

FIG. 4 is an illustrative block diagram of components in the remote control as shown in FIG. 1 in accordance with the present invention.

FIG. 5 is a flow chart of a setting method of the remote control for a household appliance in accordance with a preferred embodiment of the present invention.

### DETAILED DESCRIPTION OF THE INVENTION

In order to facilitate understanding of the present invention, the following descriptions accompanying attached drawings are presented to further completely describe the present invention. Attached drawings show a preferred embodiment of the present invention. However, the present invention may be implemented by many different forms thereof and is not limited to the preferred embodiments described herein. On the contrary, the purpose of providing these embodiments is for much more thorough and entire understanding of the published disclosure of the present invention.

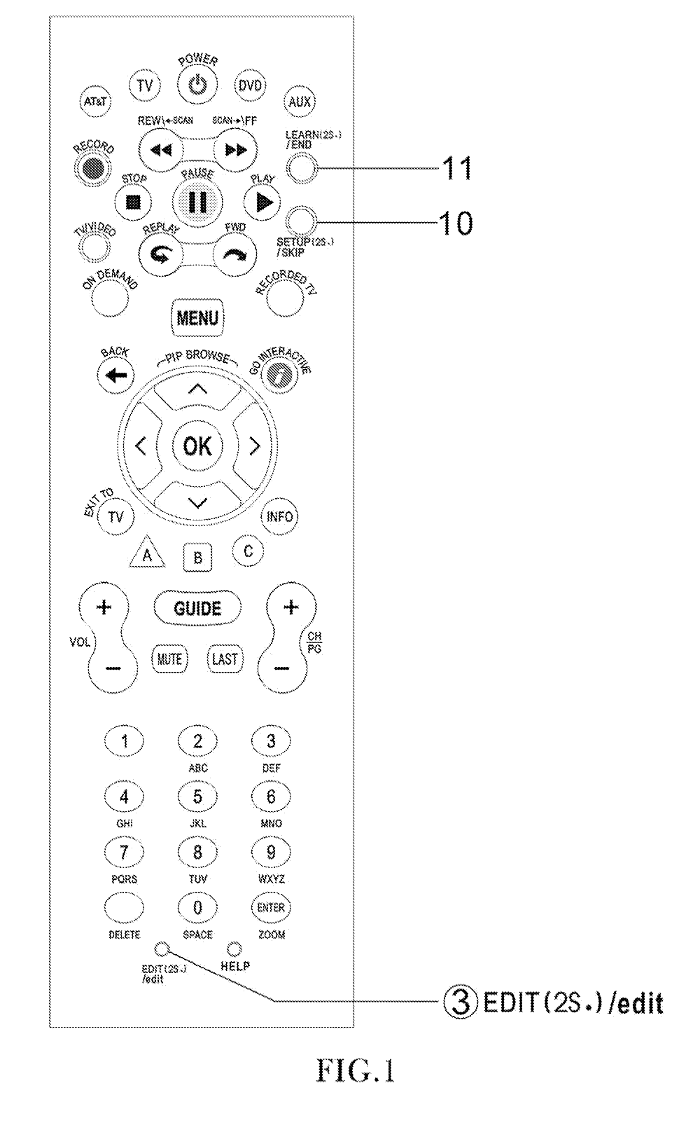

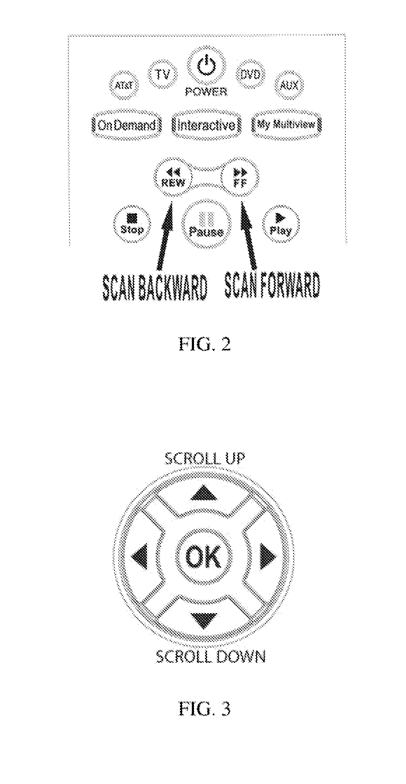

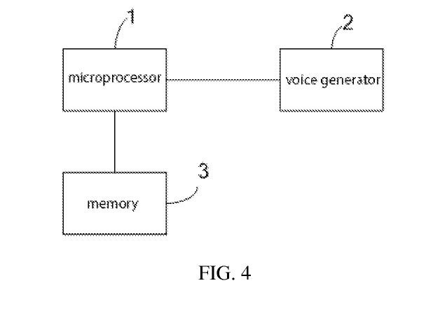

Referring to FIG. 1 to FIG. 4, a remote control for a household appliance in accordance with a preferred embodiment of the present invention comprises a built-in microprocessor 1, a built-in voice generator 2 signally and data communicable with the microprocessor 1, and a memory 3 signally and data communicable with the microprocessor 1. The voice generator 2 is able to generate voice prompt(s) in sequence under control of the microprocessor 1 for guiding users of the remote control to follow instruction(s) from the voice prompt(s) in order to operate the remote control step by step or to complete setting of the remote control based on the instruction(s). A database/library is previously established and stored in the memory 3. The database is used to save and provide at least instruction(s) for voice prompt(s) and infrared (IR)/control codes for remote controls corresponding to various brands and manufacturers of household appliances.

In a preferred embodiment of the present invention, the remote control is a universal remote control, and the universal remote control comprises the database in the memory 3 to store the IR/control codes used to set up the universal remote control corresponding to an assigned household appliance which is desired to be remotely controlled. The IR/control code are a control code corresponding to a set of keys provided on a control panel of the remote control designated for remote controlling the assigned household appliance, or at least a control code corresponding to a plurality of commonly used keys for most of remote controls, such as “Turn On” key, “Turn Off” key, “Mute” key, numeric keys, “Volume Up” key, “Volume Down” key, “Forward” key, “Back” key, and so on. In order to find a correct control code for the remote control, brands and/or manufacturers of the assigned household appliance are used as a reference to the correct control code. As long as a required brand and/or manufacturer of the assigned household appliance is found, a corresponding control code is automatically retrieved from the database and is output to the microprocessor 1 for further use.

In a preferred embodiment of the present invention, a “SETUP/SKIP” key 10 on the control panel of the remote control is set to start a setting up of the remote control. The voice prompt(s) is triggered when the “SETUP/SKIP” key 10 is pressed and held in a preset way. The voice prompt(s) comprises instruction(s) for users to follow and for guiding the users to find out a particular IR/control code for the assigned household appliance. In a preferred embodiment of the present invention, a first English letter of brands and/or manufacturers of the assigned household appliance is requested to input based on instruction(s) of the voice prompt(s). Based on the input first English letter, the particular IR/control code for the assigned household appliance is searched and found from the database. The numeric keys on the control panel of the remote control are used for input of the first English letter. For example, the “2” key out of the numeric keys is used for keying in the letters “A”, “B” and “C” based on pressing time(s) of the “2” key. The input English letter is repeated by voice prompt(s) after being keyed in for confirmation, and all of brands and/or manufacturers being started with the input English letter are prompted one by one immediately after user's confirmation in order to find out the correct brands and/or manufacturers of the assigned household appliance. After the correct brand and/or manufacturer is heard by users out of the voice prompting, a scan forward “SCAN→/FF” key is set to be pressed for confirmation and the remote control is automatically set up by a corresponding control code based on the heard correct brand and/or manufacturer. After the remote control is set based on the corresponding control code, an automatic self-check of the remote control is initiated in order to test each key of the remote control available for the assigned household appliance. During testing of each key of the remote control available for the assigned household appliance, a “POWER” key is tested last to switch off the assigned household appliance first and then automatically switch on the assigned household appliance in a preset time period. In another embodiment of the present invention, the “POWER” key is required to be pressed after it is tested to switch off the assigned household appliance. In a preferred embodiment of the present invention, the “SCAN→/FF” key is pressed one time to test only one key of the remote control, and other keys are tested one by one after the “SCAN→/FF” key is pressed again. In the case that no control code can be found from the database, a “LEARN/END” key 11 is set to initiate a learning mode of the remote control to learn a new control code from the assigned household appliance or another remote control for the assigned household appliance.

In a preferred embodiment of the present invention, a scrolling up “↑” key and a scrolling down “↓” key are used to start voice prompt(s) including a list of popular brand/manufacturer names stored in the database. Users can confirm and find the required control code for the remote control when the correct brand/manufacturer name is heard for the list.

The remote control for household appliances of the present invention uses the voice generator 2 to generate voice prompt(s) under control of the microprocessor 1 and guide users for operation and/or setting up of the remote control by following the voice prompt(s) step by step. Setting of the remote control, as well as other operation on the remote control, can be easily completed due to help of the voice prompt(s). Gradually learning of the remote control from the assigned household appliance or another remote control will not required, and setting of the remote control or some other operation on the remote control can be completed by the remote control itself. As a result, much flexible and simplified steps during learning of the remote control can be adopted, and operation and setting of the remote control is simple and fast. Moreover, fast setting of the remote control for household appliances of the present invention can be achieve and only one remote control is required during setting of the remote control of the present invention to achieve control of various household appliances.

A function of “Following Me” of the remote control of the present invention to search control codes in the database is specified as the following.

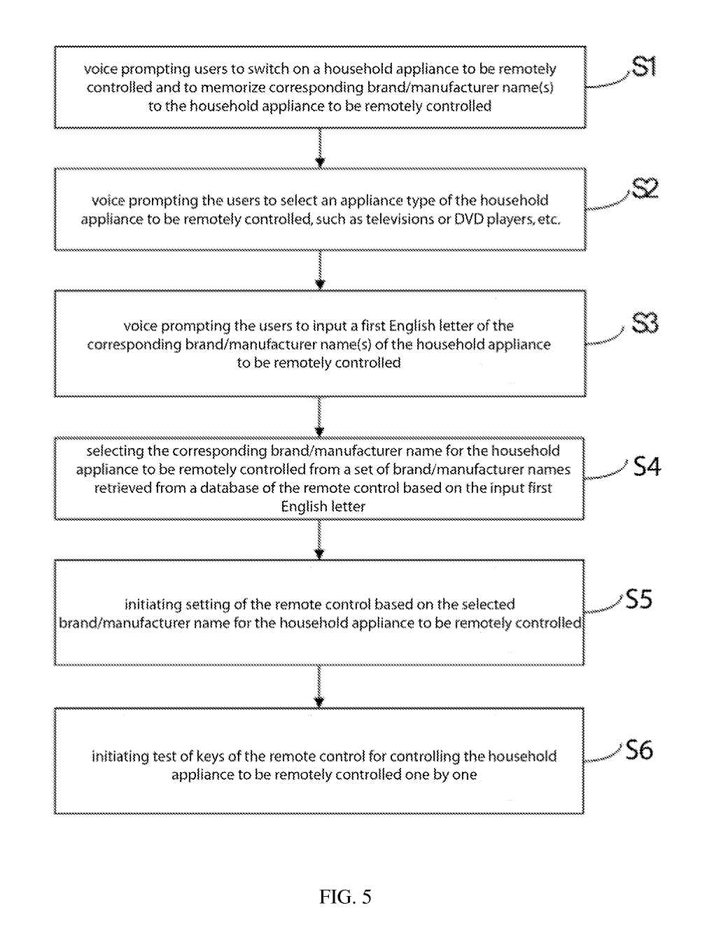

Referring to FIG. 5, a setting method of the remote control for a household appliance in accordance with a preferred embodiment of the present invention comprises step S1, voice prompting users to switch on a household appliance to be remotely controlled and to memorize corresponding brand/manufacturer name(s) to the household appliance to be remotely controlled; step S2, voice prompting the users to select an appliance type of the household appliance to be remotely controlled, such as televisions or DVD players, etc.; step S3, voice prompting the users to input a first English letter of the corresponding brand/manufacturer name(s) of the household appliance to be remotely controlled; step S4, selecting the corresponding brand/manufacturer name for the household appliance to be remotely controlled from a set of brand/manufacturer names retrieved from a database of the remote control based on the input first English letter; step S5, initiating setting of the remote control based on the selected brand/manufacturer name for the household appliance to be remotely controlled; and step S6, initiating test of keys of the remote control for controlling the household appliance to be remotely controlled one by one.

In a preferred embodiment of the present invention, in steps Si and S2, the “SETUP/SKIP” key 10 is pressed and held by users for a preset time period. Voice prompting such as “Power on your device that you want to set up, then select and press the device key including TV, DVD and AUX to identify the device that you want to set up” is generated by the voice generator 2 under control of the microprocessor 1 of the remote control for users. In step S3, voice prompting such as “Enter the first letter of the brand name of your device by pressing the number key of your new remote, and press 1, 2, 3 times respectively to choose the first, second, third letters represented by the number key” is generated by the voice generator 2 for users to input the first English letter of the brand/manufacturer name of the household appliance to be remotely controlled. In step S4, the corresponding brand/manufacturer name for the household appliance to be remotely controlled can be directly selected if only one brand/manufacturer name has the same input first English letter for time saving. Otherwise, a set of brand/manufacturer names retrieved from the database of the remote control based on the input first English letter will be voice prompted for users to choose. In step 5, a proper IR/control code is retrieved from the database by the microprocessor 1 of the remote control based on the selected brand/manufacturer name in order to set up the remote control so that the remote control is ready for remotely controlling the household appliance to be remotely controlled. In step S6, voice prompting is generated to instruct users for pressing the “SCAN→/FF” key repeatedly so that every key of the remote control available for remotely controlling the household appliance to be remotely controlled can be tested one by one by automatically remotely controlling the household appliance to be remotely controlled. The “POWER” key of the remote control is tested last to switch off the household appliance to be remotely controlled, and the household appliance to be remotely controlled can be manually switched on or automatically switched on in a preset time period after being switched off by the remote control.

In a preferred embodiment of the present invention, in step S5, the IR/control code is retrieved from a sever data communicable with the remote control when the control code is unavailable in the database based on the selected brand/manufacturer name. The newly retrieved control code is then written into the database of the remote control for future use. A Bluetooth module or WIFI module can be built-in in the remote control and electrically connected with the built-in microprocessor 1 to achieve the above-mentioned data communication. Preferably, to save hardware costs, the above-mentioned data communication can be achieved by an Infrared transmitter/receiver electrically connected with the built-in microprocessor 1 of the remote control.

In a preferred embodiment of the present invention, after step S6, voice prompting to guide users to verify whether setting of the remote control is successful is generated, and a confirmation key on the remote control is required to be pressed for completion of setting of the remote control.

In a preferred embodiment of the present invention, the required IR/control code can be input directly into the remote control in other ways, such as copying from another remote control via an Infrared transmitter/receiver, or keying in from the control panel of the remote control.

In a preferred embodiment of the present invention, voice prompting regarding fast setup keys is also available if the required brand/manufacturer names are popular or frequently used. A “HELP” key on the control penal of the remote control is pressed and held for a preset time period, and the voice prompting will be heard by users including popular brand/manufacturer names such as “HAIER”, “SAMSUNG”, and so on. In the case a required brand/manufacturer name is heard, the “SCAN→/FF” key can be pressed as above described in step S6.

Descriptions and applications of the present invention herein are intended to be illustrative, not intended to limit the scope of the present invention to the above described embodiment. Variations and modifications of the embodiment disclosed herein are possible, and for those of ordinary skilled in the field, alternatives and equivalents of various components of the embodiment disclosed herein are common senses and well known. Where any person skilled in this art should know that the present invention can be achieved in other forms, structures, arrangements, proportions, and with other components, materials, and parts, the changes or improvements are still covered within the inventive spirit of the present invention and the scope as defined in the following claims. Without departing from the spirit and scope of the present invention, other modifications and changes of the embodiment disclosed herein can be made and still be covered by the claimed scope of the following claims.

What is claimed is:

1. A remote control for remotely controlling household appliances, comprising:
a microprocessor;
a memory being data communicable with the microprocessor for storing a preset database; and
a voice generator being data communicable with the microprocessor, and being controlled by the microprocessor to generate voice prompts for users to follow and operate the remote control step by step; wherein
voice prompts are generated by the voice generator under control of the microprocessor to prompt users step by step when the remote control is set up to remotely control a household appliance to be remotely controlled, a first letter of a brand name corresponding to the household appliance to be remotely controlled is input in the remote control by following the generated voice prompts to decide a control code retrieved from the database for setting up the remote control, and further voices prompts are generated to prompt users for testing each key available for remotely controlling the household appliance to be remotely controlled when the corresponding brand name is input and the control code is decided to finish setting up of the remote control.

2. The remote control as claimed in claim 1, wherein the control code is an infrared (IR) code for setting up of the remote control, each IR code is stored in the database correspondingly to a brand name of an assigned household appliance to be remotely controlled by the remote control.

3. The remote control as claimed in claim 1, further comprising numeric keys disposed on a control panel of the remote control and used for inputting of the first letter.

4. The remote control as claimed in claim 1, wherein the a set of brand names starting with the input first letter and being retrieved from the database is voice prompted for users to select the brand name corresponding to the household appliance to be remotely controlled from the set of brand names.

5. The remote control as claimed in claim 1, wherein a list of popular brand names is stored in the database for use of voice prompting users to select the brand name corresponding to the household appliance to be remotely controlled from the list.

6. A method to operate a remote control of household appliances, comprising:
establishing a database in the remote control;
voice prompting the users to input a first letter of a brand name corresponding to a household appliance to be remotely controlled;
voice prompting a set of brand names retrieved from the database of the remote control and starting with the input first letter for users to select the brand name corresponding to the household appliance to be remotely controlled; and
completing setting of the remote control to make the remote control available for remotely controlling the household appliance to be remotely controlled by using the database based on the selected brand name.

7. The method as claimed in claim 6, further comprising a step of initiating test of keys of the remote control available for controlling the household appliance to be remotely controlled one by one.

8. The method as claimed in claim 6, further comprising a step of voice prompting users to switch on the household appliance to be remotely controlled and to memorize a brand name corresponding to the household appliance to be remotely controlled.

9. The method as claimed in claim 6, further comprising a step of voice prompting users to select an appliance type of the household appliance to be remotely controlled.

10. The method as claimed in claim 6, wherein a control code used to set up the remote control ready for remotely controlling the household appliance to be remotely controlled is retrieved from the database after the brand name corresponding to the household appliance to be remotely controlled is selected.
